(19) United States
(12) Patent Application Publication
(10) Pub. No.: US 2002/0004877 A1
(43) Pub. Date: Jan. 10, 2002

(54) METHOD AND SYSTEM FOR UPDATING USER MEMORY IN EMULATOR SYSTEMS

(76) Inventor: BRIAN BOLES, MESA, AZ (US)

Correspondence Address: BAKER BOTTS, LLP, 910 LOUISIANA, HOUSTON, TX, 77002-4995, US

(21) Appl. No.: 09/291,190

(22) Filed: Apr. 14, 1999

(51) Int. Cl. G06F 12/00

(52) U.S. Cl. 711/102; 703/21

(57) ABSTRACT

A device, system and method for providing access to user memory in emulator systems. The emulator system contains an emulator system memory, a user system memory and an emulator device. The emulator device operates in a mode where program execution instructions originate in the emulation memory while read and write instructions target the user memory. Logic included in the emulator chip directs the read and write memory accesses to the user memory while instructions are fetched from the emulator memory.

### BACKGROUND OF THE INVENTION

1. Field of the Invention

The present invention relates to an emulator system and emulator device, and in particular to an emulator system and emulator device able to easily update both off-chip and on-chip memory.

2. Discussion of the Background

Many microcontroller devices have memory systems that include on-chip memory and off-chip user memory. In emulator systems, there is a requirement to be able to update the contents of both types of memory. Generally, the emulator system can easily update the on-chip memory while updating the off-chip memory is more complicated. For example, one conventional method to gain access to the user memory is to provide a duplicate direct access through a duplicate emulator control block. A host system using the emulator system directly controls the user memory using the emulator control block. In another manner, an existing emulator control block may be equipped with additional connectivity and an additional bus. Either using a duplicate emulator control block or having to add further connectivity and another bus increases both the cost and complexity of the system.

In another conventional system, the PIC17C01 emulator device manufactured by the assignee of this application, access is possible to both on-chip (emulator program) and off-chip (user) memory. However, the emulator device must generate memory access cycles to access the off-chip memory by manipulating I/O bits. More particularly, when needing to read from the user memory, a host system downloads program segments from the emulator program memory and begins to execute the segment in the PIC17C01. The program segment writes to port C, D and E data latches, and writes to port C, D and E data direction registers (DDRs) to configure them as outputs. The host system changes from MP mode to MC mode, changing ports C, D and E fro system bus mode to I/O port mode. The DDRs have been previously set up and are driven as outputs. The host system starts downloading program segments into the emulator program memory execution of the program segments within the PIC17C01, and starts execution of the program segments within the PIC17C01.

The program segment then writes to ports C, D and E to emulate a system bus and read the desired memory location. A RAM address is written to ports C and D, and port E is set such that ALE strobes high. Ports C and D of the DDR are written to, configuring them as inputs, and DDR port E is set such that OE strobes low. Data is read on ports C and D, and the data is stored in RAM in the PIC17C01. The host system then changes from MP to MC mode, downloads program segments into the emulator program memory, and starts execution of the program segments in the PIC17C01. The program segment transfers the data in RAM to the host system.

The write procedure is similar where the program segment, downloaded into the emulator program memory, when executed writes a RAM address to ports C and D and sets port E such that ALE strobes high. DDR ports C and D are written with data to be written into the user program memory, and DDR port E is set such that WR strobes low.

### SUMMARY OF THE INVENTION

It is an object of the present invention to provide an emulator system, device and method providing simple and efficient access to off-chip user memory.

It is another object of the invention to have an emulator system and device where code is executed in the emulation memory and read and write accesses are directed towards the off-chip user memory.

It is a further object of the present invention to provide an emulator device connected to an emulator system and a user system providing simple and efficient access to program memory in the user system.

These and other objects of the invention may be achieved by an emulator device having a memory interface for accessing a program memory, the program memory having a first memory, and a second memory external to the device, and a selection circuit connected to the interface for directing program memory write and memory read accesses only to the second memory when the device is configured to fetch instructions from the first memory.

The device may further include a circuit connected to the selection circuit detecting whether at least one of a table read and a table write access is to be executed, and the selection circuit may direct the table read and table write accesses only to the second memory. The device may also include a mode selection circuit, where the selection circuit comprises a switching device connected to the first and second memories and connected to receive a signal output by the mode selection circuit.

An instruction decoder may also be included in the device, outputting a signal indicating at least one of a program memory read access and a program memory write access instructions to be decoded. A circuit may be connected to the decoder configured to receive the signal and configured to execute at least one of the program memory read access instruction and the program memory write access instruction.

When the device has the mode selection circuit, the circuit may also include a logic circuit connected to receive an output of the mode selection circuit, and an instruction decoder having an output connected to the logic circuit, where the interface circuit is connected to the output of the logic circuit.

The mode selection circuit may comprise means for outputting a signal indicating a mode of operation of the device, and the instruction decoder may comprise means for outputting a signal indicating at least one of a program memory read or write access is to be decoded. The logic circuit may be connected to receive the signals output by the two means and outputs a signal to the selection circuit indicating to which of the first and second memories access is enabled.

The memory interface may comprise a program memory bus and a program memory bus controller connected to the bus. The selection circuit may comprise a multiplexer connected to the program memory bus, a first memory access bus and a second memory access bus, and circuitry connected to the multiplexer for selecting between the first and second memory access busses. This circuitry may comprise means for generating a signal output to the multiplexer indicating access to only the second memory when the device is configured to fetch instructions from the first memory. This means may comprise a mode selection circuit, a circuit generating a signal indicating program memory accesses to be executed, and a first logic circuit connected to receive an output of the mode selection circuit and having an input connected to receive the signal output by the circuit.

The first memory may be an emulator program memory and the second memory may be a user program memory.

An emulator system and a user system may also be connected to the device. The emulator system may comprise the first memory and the user system may comprise the second memory. The first memory may comprise an emulator program memory and the second memory may comprise a user program memory.

The objects described above and other objects may also be achieved by an emulator device having a means for receiving instructions originating from an emulation memory connected to the device, and means, connected to the means for receiving, for targeting only memory read and write instructions to a user memory connected to the device when the device is configured to fetch instructions from the emulation memory. The device may also comprise a means for detecting memory read and write instructions, connected to the means for receiving, and a means for selecting a mode of operation of the device connected to the means for targeting and to the means for detecting.

The means for targeting may comprise a means for detecting a mode of operation of the device, a means for detecting the memory read and write instructions, and a means for selecting access between the emulation memory and the user memory using outputs of both of the means for detecting. The device may also include a means for switching between access to the emulation memory and the user memory under control of the means for selecting.

The above objects and other objects may also be achieved by a method of operating an emulator device having the steps of fetching instructions only from a first memory, and directing memory accesses only to a second memory separate from the first memory and external to the emulator device. Instructions may be fetched only from an emulation program memory, and the memory accesses may be directed only to a user program memory separate from the emulation program memory. The method may also include directing at least one of a table read and table write access to the program memory.

The method may also include detecting a mode of operation of the device, detecting whether a memory access is to be performed, and selecting access between the first and second memories based upon the detecting steps. Detecting whether a memory access is to be performed may comprise detecting whether at least one of a table read and a table write access is to be performed, and directing the memory access may comprise directing at least one of the table read and table write access to the second memory.

The method may also include decoding instructions, detecting whether a memory access is to be performed using the decoding step, and determining which of the first and second memories is to be accessed using the detecting step. A mode of operation of the device may also be detected, and determining which of the first and second memories is to be accessed may be performed using the detecting steps.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a simplified block diagram of the emulator system according to the invention;

FIG. 2 is a block diagram of the emulator chip according to the invention;

FIG. 3 is a diagram of circuitry included in the emulator chip according to the invention;

FIGS. 4A-4C are diagrams of the emulation memory map in different modes of operation;

FIG. 5 is a diagram of a table read command according to the invention; and

FIG. 6 is a diagram of a table write command according to the invention.

### DESCRIPTION OF THE PREFERRED EMBODIMENT

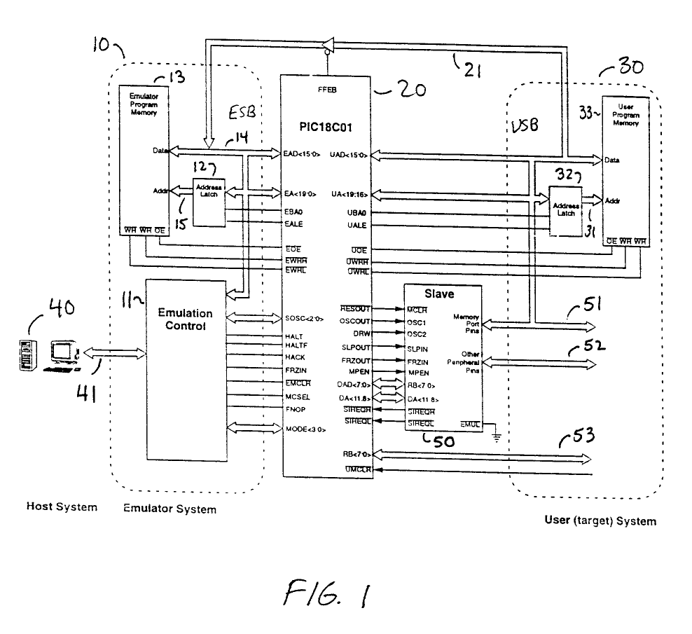

Referring now to the drawings, and more particularly to FIG. 1, which shows an embodiment of the system according to the invention. The system includes an emulator system 10, emulator chip 20, and user system 30. Emulator system 10 contains emulation control circuitry 11, an address latch 12 and an emulator program memory 13. A host system 40 communicates with emulator system 10 through bus 41 connected between host system 40 and emulation control circuitry 11. Addresses from emulator chip 20 are input to address latch 12 and data is transferred between memory 11 and chip 20 via bus 14. Emulation control circuitry 11 is also connected to bus 14. Addresses from latch 12 are input to emulator program memory 13 through bus 15.

Address latch 12 is connected to the EA, EBA0 and EALE pins while the emulation control 11 is connected to several pins of chip 20. Program memory 13 is also connected to the emulator output enable, emulator write high and emulator write low pins of chip 20. Bus 21 is connected between system 10, chip 20, and system 30.

User system 30 contains user program memory 33 and address latch 32. Addresses from chip 20 are fed from latch 32 to memory 33 by bus 31. Pins UAD of chip 20 are connected to the data input of memory 33, and pins UA, pin UBA0 and pin UALE are connected to address latch 32. User memory output enable, user write high and user write low pins are also connected to program memory 33.

It should be noted that the emulation program memory 13 and the user memory 33 are typically of different size. The off-chip memory 33 is usually larger.

A number of the pins from chip 20 are also connected to slave device 50. Slave device 50 provides a portion of the emulator function. Emulator chip 20 is designed to emulate the central core of most devices. The slave device emulates the peripheral functions of the devices. Chip 20 and slave 50 work together to emulate the desired device. Chip 20 and slave 50 are designed to be separate to allow emulation of different types of devices with different peripheral functions by simply using a different slave device. Connections 51-53 to slave device 50 illustrate the connection of the chip 20 and slave 50 with the “target” system. In other words, this is where the emulator replaces the chip in the user system.

In the present invention, chip 20 is placed into a desired mode of operation. In one mode, termed the microprocessor write-through mode (MP/W) and discussed in more detail below, Program execution within chip 20 occurs from emulator program memory 13 while table read and table write instructions occur in user program memory 33. Host system 40 downloads program segments into emulator program memory 13 using emulation control circuitry 11. Host system 40 begins execution of the program segments within chip 20. When reading memory 33, the program segment performs a table read instruction to read memory 33. The program segment executing within chip 20 transfers data from chip 20 to host system 40 via circuitry 11 and bus 41.

A similar operation occurs when writing to program memory 33. Chip 20 is placed in MP/W mode, directing program execution to occur from emulator program memory 13 while table read and table write instructions occur in user program memory 33. Host system 40 downloads program segments into emulator program memory 13 using emulation control circuitry 11. Host system 40 begins execution of the program segments within chip 20. The program segment performs a table write instruction to write data to memory 33. Data stored within chip 20 is transferred to memory 33.

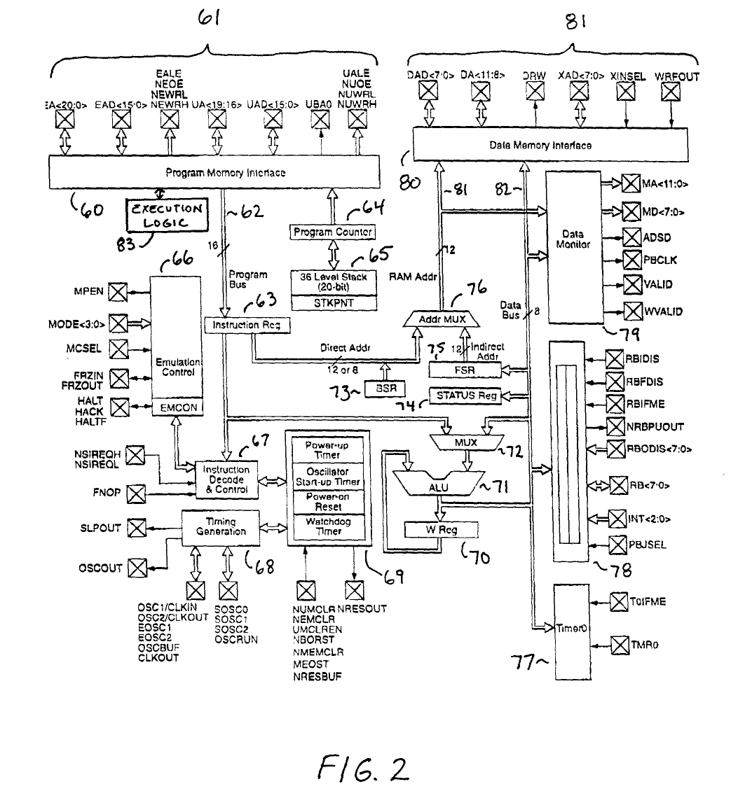

A more detailed diagram of chip 20 is shown in FIG. 2. A program memory interface 60 interfaces with emulator program memory 13 and user program memory 33 via pins 61. For example, inputs EA and EAD interface with the emulator program memory 13 while inputs UA and UAD interface with user program memory 33. Instructions input to the device are loaded into instruction register 63 via program bus 62. Instruction register 63 is interconnected with instruction decode and control 67 and address multiplexer 76. FIG. 2 also shows emulation control circuitry 66 receiving a number of inputs from emulation control 11 of emulator system 10. Of note is the 3-bit mode input which is discussed in more detail below.

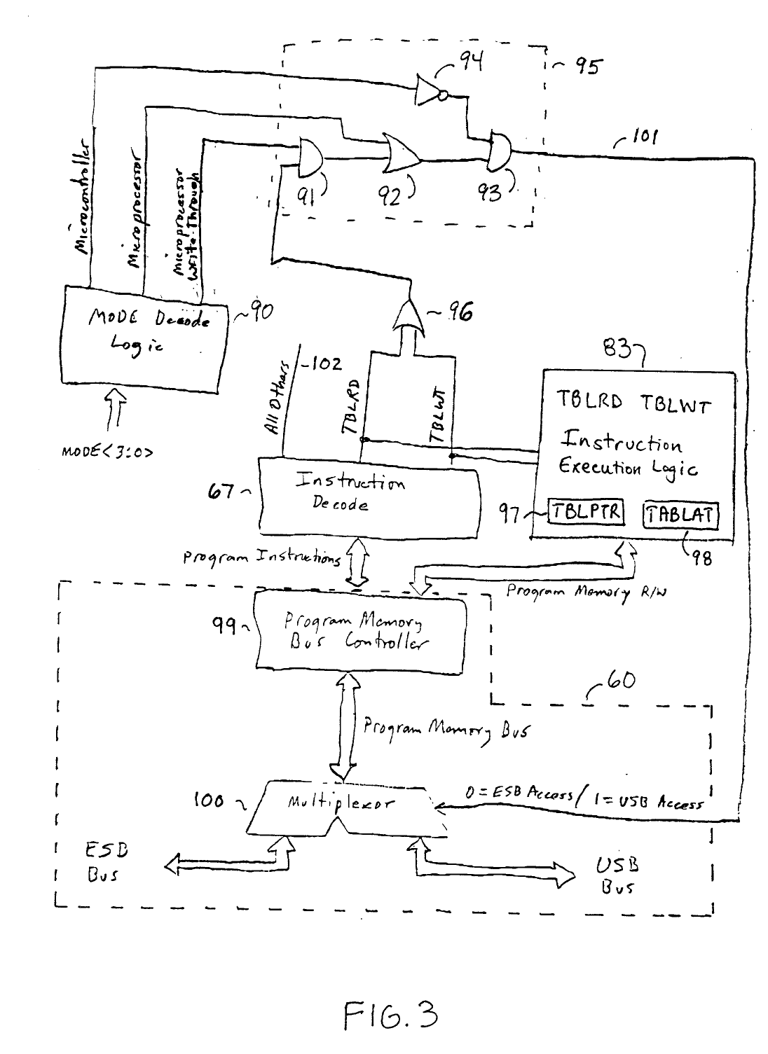

Connected to the interface 60 is table read and table write execution logic circuit 83. Circuit 83 is connected to interface 60 by a bus. Circuit 83 is also connected to instruction decode 67, but not illustrated in this figure, and carries out execution of program memory read and write instructions, termed table read and write instructions. Circuit 83 also contains registers TBLPTR and TABLAT used in executing table read and table write instructions. The operation of this circuit is described in more detail below in connection with FIG. 3 and FIGS. 5 and 6.

Chip 20 also includes timing generation 68 for generating various timing signals used throughout chip 20, and circuitry 69 including elements such as a power-up timer, an oscillator start-up timer, a power-on reset and a watchdog timer. ALU 71 having working register (W Reg) 70 are connected to various circuits, such as timer 77, peripherals 78 and data monitor 79 through bus 82. The chip includes several registers, some of which are not shown for brevity. Shown are bank select register (BSR) 73, status register 74 and file select register (FSR) 75. A data memory interface 80 is provided to handle the transfer of data to and a data memory (emulating data RAM) via pins 81. The data memory typically resides in slave 50. Addresses received from instruction register 63 and fed through the address multiplexer 76 are input to the data memory interface 67 through RAM address bus 81.

It is to be understood that FIG. 2 is not a complete diagram of chip 20 and many other circuits and interconnects are not shown. FIG. 2 is included to illustrate the invention and is not meant to show every feature of chip 20.

Reading and writing to program memories in a microprocessor are typically carried out through instructions called table read and table write. These instructions allow transfer of information between a data memory space and a program memory space. In the present invention, logic in emulator chip 20 redirects the table read and table write commands to allow access to the user memory. Thus, the user memory 33 is easily accessed. This will become evident in the following description.

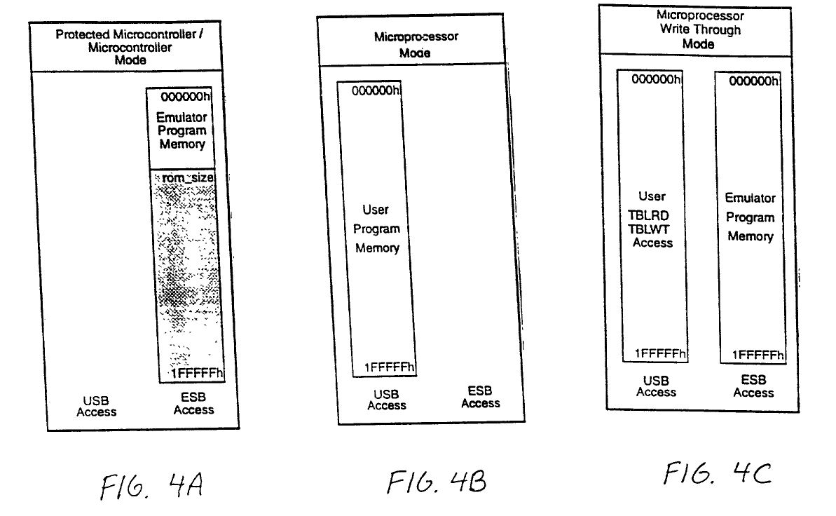

An even more detailed review of some of the circuitry included in chip 20 is shown in FIG. 3. A mode decode logic circuit 90 receives as inputs the 3-bit mode signal from the emulation control circuit 66. Mode decode logic decodes the three-bit signal and outputs a logic “1” signal on the appropriate output line corresponding to the desired mode of operation. In this case, a microcontroller mode, a microprocessor mode, and a microprocessor write-through mode are illustrated. The memory mapping for each of these modes is shown in FIGS. 4A-4C, and are discussed in more detail below. It is to be understood that the three modes are merely used as illustration of the invention, and further modes of operation are possible.

FIGS. 4A-4C show the emulation memory map in different modes of operation. FIG. 4A shows the protected microcontroller/microcontroller mode where access is only provided to the emulation memory. In microprocessor mode (FIG. 4B) access is only provided to the user memory. On the other hand, FIG. 4C shows a mode called the microprocessor write-through mode where all program execution instructions originate from the emulation memory while read and write table operation instructions originate in or target the user memory.

The mapping shown in FIGS. 4A-4C is illustrated for understanding the invention, it is not to imply that the user and emulator memories are of the same size, or are required to be of the same size. Typically the off-chip user memory is much larger than the emulator program memory.

The circuit of FIG. 3 also includes a multiplexer 100 connected to emulator system bus 14 and user system bus 21. Multiplexer 100 is controlled by an output of logic circuitry 95 which outputs a signal on signal line 101 directing the multiplexer to allow ESB access or USB access. Circuit 95 includes AND gates 91 and 93, inverter 94 and OR gate 92. Connected to multiplexer 100 through the program memory bus is program memory bus controller 99 controlling the program memory reading and writing. Instructions received from the program memories are input to instruction decode circuitry 67.

Table read/Table write instruction execution logic 83 is connected to decode circuit 67 via the signal lines labeled TBLRD and TBLWT. Circuit 83 contains two registers TBLPTR 97 and TABLAT 98 used in executing the table read and table write instructions, the use of which is described in more detail below. Circuit 83 is connected by a program memory read/write bus to program memory bus controller 99. The TBLRD and TBLWT signal lines are fed to an OR gate 96, the output of which is fed to an input of AND gate 91. The signal line 102 represents the output of all other decoded instructions which are fed to the appropriate circuits of the emulation device for execution. One example is the ALU for executing arithmetic operations.

An operation of the circuit of FIG. 3 will now be described. There are three types of memory cycles that may occur in the circuit of FIG. 3. These are an instruction fetch, a table read from the TBLRD instruction, and a table write from the TBLWT instruction. Instructions are sent to the instruction decode 62. The instructions are decoded into table read, table write and other instructions, which are indicated in FIG. 3 schematically as a group on output 102. When either TBLRD or TBLWT are detected, the instruction execution logic 83 is signaled. Logic 83 will send to controller 99 a program memory access. Depending on the signal on the mode pin inputs, the multiplexer will direct the program memory access to the ESB if the multiplexer control signal is logic “0” and will direct a program memory access to the USB if the multiplexer control signal is logic “1.”

The mode selection determines the memory to be accessed. In the microcontroller mode, it is always desired to direct the memory access to the ESB. Thus, the MC mode signal is inverted and then sent to AND gate 86 such that the multiplexer control signal is always logic “zero”. In the microprocessor mode, it is always desired to direct the memory access to the USB, so the microprocessor mode signal is sent to OR gate 88 such that the multiplexer control signal is always logic “1”.

The AND gate 91 receives as inputs the microprocessor write-through signal and a signal generated from OR gate 96. A logic “1” OR gate 96 signal is generated when either of a read or write instruction has been decoded by instruction decode 67, since logic “1” signals are output on either of the table read or table write lines. This output of OR gate 96 is fed to AND gate 91, which also receives as an input the microprocessor write-through output of mode decode logic 90. When both of the signals input to AND gate 91 are high, a logic “1” signal is output from AND gate 91, causing a logic “1” signal to be output from OR gate 92. AND gate will then output a logic “1” signal since in the microprocessor write-through mode, the signals on microcontroller line and the microprocessor line are logic “zero” by definition. In the microprocessor write-through mode, read and write instructions are targeted to the USB while all other memory accesses associated with any other instruction are targeted to the ESB. Thus, chip operates by fetching instructions from the ESB system 10 while any table read or table write instructions are carried out in the USB system 30. The emulator device according to the present invention allows one to simply execute instructions from the emulator program memory while reading and writing to and from the user program memory in this mode.

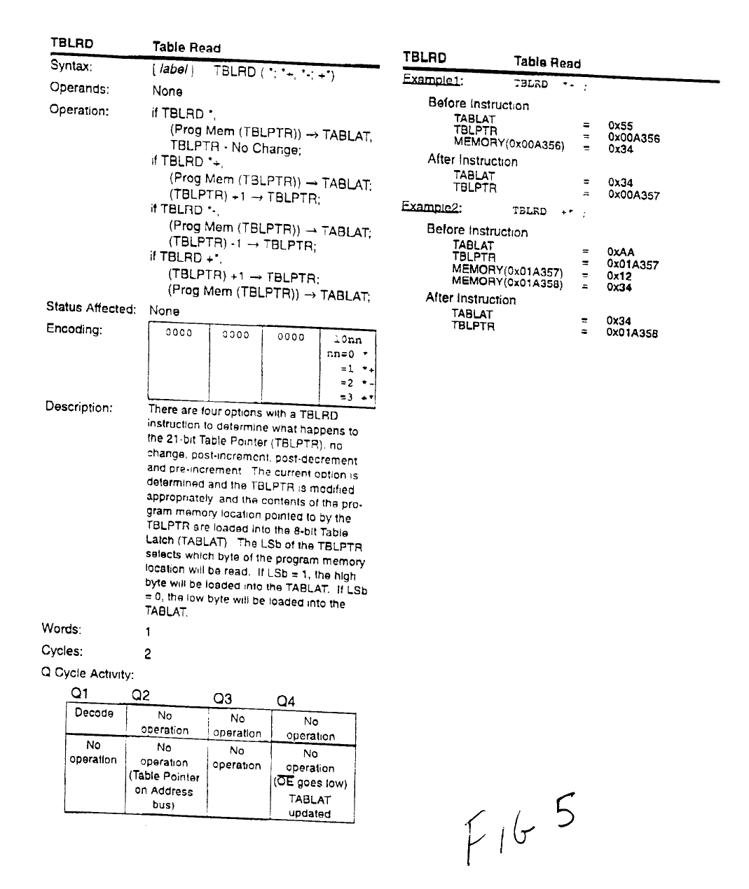

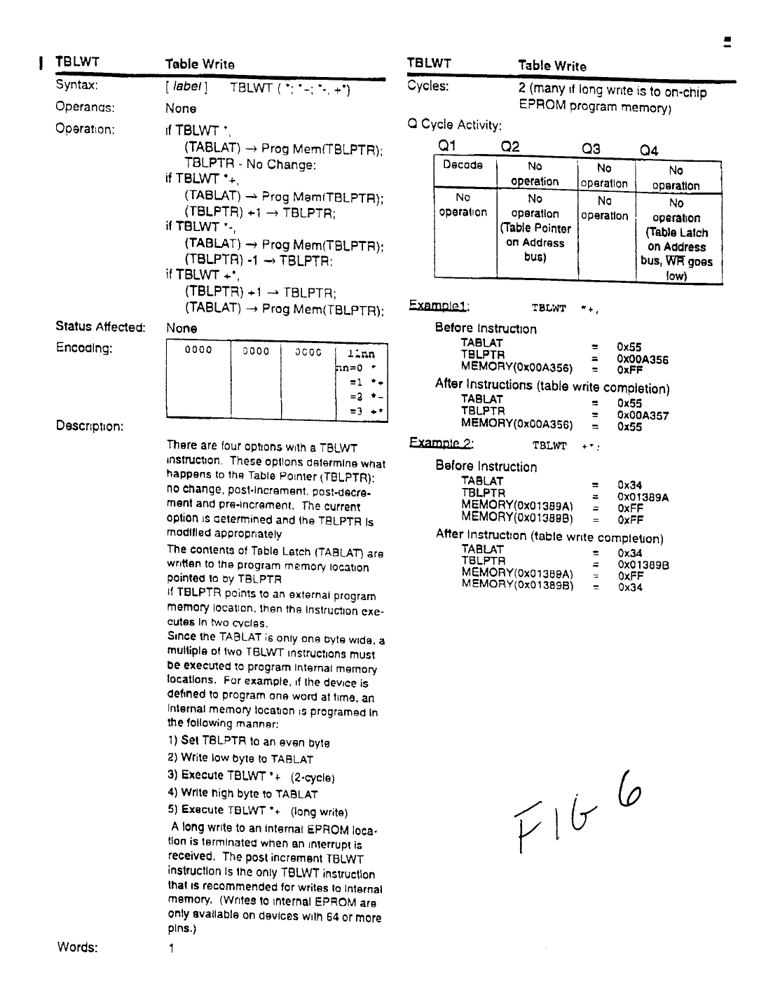

The table read and write operations are shown in more detail in FIGS. 5 and 6. In the table read command, shown in FIG. 5, two registers in chip 20 are described. A TABLAT register is a table latch and hold 8 bits. This register holds the contents of a memory location pointed to by the address loaded into 21-bit table pointer register TBLPTR. Four options are available for the TBLRD instruction. In three cases the data at the memory location in user memory 33 pointed to by TABLPTR is loaded into TABLAT. As specified by the operand, the value in TBLPTR is left unchanged, or incremented or decremented after the value is loaded into TABLAT. The value of TBLPTR is incremented and location in memory 33 pointed to by the incremented value in TBLPTR is loaded into TABLAT in the fourth case.

The table write instruction is performed similarly. As shown in FIG. 6, four options are also available for the TBLWT instruction. In three cases the data in TABLAT is loaded into the memory location of user memory 33 pointed to by TABLPTR. As specified by the operand, the value in TBLPTR is then left unchanged, or incremented or decremented. The value of TBLPTR is incremented and the data in TABLAT is loaded into the memory location of user memory 33 pointed to by the incremented value in TBLPTR in the fourth case.

Obviously, numerous modifications and variations of the present invention are possible in light of the above teachings. It is therefore to be understood that within the scope of the appended claims, the invention may be practiced otherwise than as specifically described herein.

What is claimed as new and desired to be protected by Letters Patent is:

1. An emulator device, comprising:
a memory interface for accessing program memory, said program memory comprising a first memory, and a second memory external to said device; and
a selection circuit connected to said interface for directing program memory write and memory read accesses only to said second memory when said device is configured to fetch instructions from said first memory.

2. A device as recited in claim 1, comprising:
a circuit connected to said selection circuit detecting whether at least one of table read and a table write access is to be executed;
wherein said selection circuit directs at least one of said table read and table write accesses to only said second memory.

3. A device as recited in claim 1, comprising:
a mode selection circuit;
wherein said selection circuit comprises a switching device connected to said first and second memories and connected to receive a signal output by said mode selection circuit.

4. A device as recited in claim 1, comprising:
an instruction decoder outputting a signal indicating at least one of a program memory read access instruction and a program memory write access instruction is to be decoded;
a circuit connected to said decoder configured to receive said signal and configured to execute at least one of said program memory read access instruction and said program memory write access instruction.

5. A device as recited in claim 1, comprising:
a mode selection circuit;
a logic circuit connected to receive an output of said mode selection circuit;
an instruction decoder having an output connected to said logic circuit;
said interface circuit connected to an output of logic circuit.

6. A device as recited in claim 5, wherein:
said mode selection circuit comprises first means for outputting a signal indicating a mode of operation of said device;
said instruction decoder comprises second means for outputting a signal indicating at least one of a program memory read access and a program memory write access is to be decoded; and
said logic circuit is connected to receive said signals output by said first and second means and outputs a signal to said selection circuit indicating to which of said first memory and said second memories access is enabled.

7. A device as recited in claim 1, wherein:
said memory interface comprises:
a program memory bus, and
program memory bus controller connected to said bus; and
said selection circuit comprises:
a multiplexer connected to said program memory bus, a first memory access bus and a second memory access bus, and
circuitry connected to said multiplexer for selecting between said first and second memory access buses.

8. A device as recited in claim 7, wherein said circuitry comprises means for generating a signal output to said multiplexer indicating access only to said second memory when said device is configured to fetch instructions from said first memory.

9. A device as recited in claim 8, wherein said means comprises:
a mode selection circuit;
a circuit generating a signal indicating program memory access is to be executed; and
a first logic circuit connected to an output of said mode selection circuit and having an input connected to receive said signal output by said circuit.

10. A device as recited in claim 1, wherein:
said first memory is an emulator program memory; and
said second memory is a user program memory.

11. A device recited in claim 1, further comprising:
an emulator system connected to said device; and
a user system connected to said device.

12. A device as recited in claim 11, wherein:
said emulator system comprises said first memory; and
said user system comprises said second memory.

13. A device as recited in claim 12, wherein:
said first memory comprises an emulator program memory containing instructions to be fetched by said device; and
said second memory comprises a user program memory to which only said program memory write and memory read accesses are directed when said device is configured to fetch instructions from said first memory.

14. An emulator device, comprising:
means for receiving instructions originating from an emulation memory connected to said device; and
means, connected to said means for receiving, for targeting only memory read and write instructions to a user memory connected to said device when said device is configured to fetch instructions from said emulation memory.

15. A device as recited in claim 14, comprising:
means for detecting said memory read and write instructions, connected to said means for receiving; and
means for selecting a mode of operation of said device connected to said means for targeting and to said means for detecting.

16. A device as recited in claim 14, wherein said means for targeting comprises:
means for detecting a mode of operation of said device;
means for detecting said memory read and write instructions; and
means for selecting access between said emulation memory and said user memory using outputs of both of said means for detecting.

17. A device as recited in claim 16, comprising:
means for switching between access to said emulation memory and said user memory under control of said means for selecting.

18. A method of operating an emulator device, comprising:
fetching instructions only from a first memory; and
directing memory accesses only to a second memory separate from said first memory and external to said emulator device.

19. A method as recited in claim 18, comprising:
fetching instructions only from an emulation program memory; and
directing said memory accesses only to a user program memory separate from said emulation program memory and external to said emulator device.

20. A method as recited in claim 19, comprising:
directing at least one of a table read and a table write access to said program memory.

21. A method as recited in claim 18, comprising:
detecting a mode of operation of said device;
detecting whether a memory access is to be performed; and
selecting access between said first and second memories based upon said detecting steps.

22. A method as recited in claim 21, wherein:
detecting whether a memory access is to be performed comprises detecting whether at least one of a table read and a table write access is to be performed; and
directing said memory access comprises directing at least one of said table read and table write access to said second memory.

23. A method as recited in claim 22, comprising:
fetching instructions only from an emulation program memory; and
directing said memory accesses only to a user program memory separate from said emulation program memory and external to said emulator device.

24. A method as recited in claim 18, comprising:
decoding said instructions;
detecting whether a memory access is to be performed using said decoding step; and
determining which of said first and second memories is to be accessed using said detecting step.

25. A method as recited in claim 24, comprising:
detecting a mode of operation of said device; and
determining which of said first and second memories is to be accessed using said detecting steps.

26. A method as recited in claim 25, comprising:
directing said memory accesses only to a user program memory separate from said emulation program memory and external to said emulator device.
